(19) United States
(12) Patent Application Publication
(10) Pub. No.: US 2011/0109550 A1
(43) Pub. Date: May 12, 2011

(54) KEYBOARD/MOUSE SET AND COMPUTER SYSTEM USING SAME

(75) Inventors: Yu-Yen Shih, Taipei (TW); Chun-Nan Su, Taipei (TW); Shu-Wei Chou, Taipei (TW)

(73) Assignee: PRIMAX ELECTRONICS LTD., Taipei (TW)

(21) Appl. No.: 12/702,995

(22) Filed: Feb. 9, 2010

(30) Foreign Application Priority Data
Nov. 6, 2009 (TW) 098137728

(51) Int. Cl. G06F 3/033

(52) U.S. Cl. 345/163

(57) ABSTRACT

A computer system includes a host, a screen and a keyboard/mouse set. The host is used for controlling operations of the computer system. The display screen is used for showing an operating frame of the computer system. A cursor is shown on the operating frame. The mouse could control a motion of the cursor in multiple resolution modes. The keyboard includes a switch element, which is triggered to switch the resolution modes of the mouse.

### FIELD OF THE INVENTION

The present invention relates to a computer system, and more particularly to a computer system having a keyboard/mouse set, in which the mouse resolution is controllable by the keyboard.

### BACKGROUND OF THE INVENTION

The term “dots per inch (DPI)” is a measure of a mouse resolution. A DPI valve indicates the number of individual coordinate points that a sensor of a mouse is received when the mouse is moved on an object's surface (e.g. a desk surface or a mouse pad) within the span of one linear inch. For example, the mouse resolution 800 DPI indicates that 800 different coordinate points are received by the sensor when the mouse is moved for one inch. When a sensing signal outputted from the mouse is received by a computer, a cursor shown on an operating frame of a display screen is synchronously moved by 800 dots. As the mouse resolution is increased, the displacement of moving the mouse with respect to the same display screen is decreased or shortened, and thus the moving speed of the cursor on the display screen become faster. On the other hand, as the mouse resolution is decreased, the displacement of moving the mouse with respect to the same display screen is increased, and thus the moving speed of the cursor on the display screen become slower.

In addition to operating the basic computer tasks, a mouse is usually used to operate a computer game. As known, the resolution of the mouse influences smoothness and precision of playing the computer game. For example, when a shooting game is played in a full-screen mode, the cursor (or gun) shown on the display screen could be quickly moved to the position of the shooting target. In this circumstance, the mouse should have a high resolution. Due to the high resolution of the mouse, the time required to moving the mouse is reduced or the displacement of the moving the mouse is shortened in order to quickly perform the shooting action. On the other hand, when a specified shooting target is selected and a sniper scope is opened to aim at the shooting target, the mouse should have a low resolution. Due to the low resolution of the mouse, the cursor (or the front sight) shown on the display screen could be precisely moved to the specified site (e.g. the head or heart) of the shooting target. Otherwise, the shooting target is readily moved out of the enlarged area of the sniper scope. From the above discussions, if the resolution of the mouse is able to be adjusted in a multi-stage manner, the user may adjust a desired mouse resolution according to different operating modes or the specific features of the computer games. In such circumstance, the user does not need to purchase many mice with different resolutions.

For adjusting the mouse resolution in a multi-stage manner, a mouse having a resolution switching key has been disclosed. FIG. 1 is a schematic perspective view illustrating a mouse having adjustable pointer moving resolution according to Taiwanese Patent Publication No. 562199. As shown in FIG. 1, a speed switching key (or button) 11 is provided on the casing of the mouse 1. By manipulating the speed-switching key 11, a resolution controlling program (e.g. a 400 DPI or 800 DPI mouse resolution program) installed in the microprocessor of the mouse 1 is selected to execute. As such, the image sensor of the mouse 1 reads the image signal at a speed corresponding to the selected resolution controlling program. The image signal is processed by the microprocessor and then transmitted to the computer host in order to achieve the mouse resolution switching purpose. In addition to the use of the speed switching key of the mouse, other approaches use a composite key to switch the mouse resolution. For example, after the left click button and the right click button of the mouse are simultaneously depressed, the scroll wheel may be rotated to switch the mouse resolution.

The method of providing a resolution switching key (speed switching key) on the mouse or using the composite key to switch the mouse resolution, however, still has some drawbacks. For example, since the switching action is too complicated, the user fails to rapidly and intuitively switch the mouse resolution. Once both hands of the user are simultaneously employed to play the computer game, the process of switching the mouse resolution may incur abrupt change of the final result. For example, when the right hand of the user continuously moves the mouse and the left hand depresses a specified key of the keyboard, the user needs to give some attention to depress or move the resolution switching key of the mouse, or give some attention to simultaneously depress the right and left click buttons and rotate the scroll wheel to adjust the mouse resolution. That is, the 1˜2 second's time period of switching the mouse resolution may incur abrupt change of the final result of the violent war situation. Furthermore, since the mouse is rapidly moved when the computer game is played, it is difficult for the user to precisely depress the resolution switching key by a forefinger, a thumb or a middle finger without the need of looking at the mouse. In such circumstance, the mouse resolution is usually erroneously switched and the performance of playing the computer game is deteriorated.

### SUMMARY OF THE INVENTION

As previously described, although the conventional mouse may be operated in multiple resolution modes, the process of switching the resolution mode is not rapid and intuitive. For obviating the drawbacks encountered from the prior art, the present invention provides a method of quickly adjusting the mouse resolution by using a keyboard to control or switch the resolution mode of the mouse.

In accordance with an aspect of the present invention, there is provided a computer system. The computer system includes a host, a screen, a mouse and a keyboard. The host is used for controlling operations of the computer system. The display screen is used for showing an operating frame of the computer system. A cursor is shown on the operating frame. The mouse is used for controlling a motion of the cursor in a first resolution mode or a second resolution mode. The keyboard includes a switch element, which is triggered to generate a first instruction. The mouse is operated in the first resolution mode or the second resolution mode to control the motion of the cursor according to the first instruction.

In an embodiment of the computer system, the switch element includes a push switch, a rotary switch or a sensor switch.

In an embodiment of the computer system, when the switch element is triggered, the mouse is successively switched between the first resolution mode and the second resolution mode to control the motion of the cursor.

In an embodiment of the computer system, the switch element includes a first resolution switch and a second resolution switch. When the first resolution switch is triggered, the mouse is operated in the first resolution mode to control the motion of the cursor. Whereas, when the second resolution switch is triggered, the mouse is operated in the second resolution mode to control the motion of the cursor.

In an embodiment of the computer system, a first icon is shown on the operating frame when the mouse is operated in the first resolution mode to control the motion of the cursor, and a second icon is shown on the operating frame when the mouse is operated in the second resolution mode to control the motion of the cursor.

In an embodiment of the computer system, the first icon exhibits a first resolution value corresponding to the first resolution mode, and the second icon exhibits a second resolution value corresponding to the second resolution mode.

In an embodiment of the computer system, the computer system further includes a keyboard/mouse receiver connected to the host. After the first instruction is wirelessly transmitted from the keyboard to the keyboard/mouse receiver, the keyboard/mouse receiver wirelessly issues a second instruction to the mouse, so that the mouse is operated in the first resolution mode or the second resolution mode to control the motion of the cursor according to the second instruction.

In an embodiment of the computer system, after the first instruction is transmitted from the keyboard to the host, the host issues a second instruction to the mouse, so that the mouse is operated in the first resolution mode or the second resolution mode to control the motion of the cursor according to the second instruction.

In an embodiment of the computer system, the computer system further includes a keyboard receiver connected to the host. The first instruction is wirelessly transmitted from the keyboard to the keyboard receiver.

In an embodiment of the computer system, the first instruction is transmitted from the keyboard to the host according to a Bluetooth transmission technology.

In an embodiment of the computer system, the first instruction is transmitted from the keyboard to the host through a keyboard signal wire.

In an embodiment of the computer system, the computer system further includes a mouse receiver connected to the host. The second instruction is wirelessly transmitted from the mouse receiver to the mouse.

In an embodiment of the computer system, the second instruction is wirelessly transmitted from the host to the mouse according to a Bluetooth transmission technology.

In an embodiment of the computer system, the second instruction is transmitted from the host to the mouse through a mouse signal wire.

In accordance with another aspect of the present invention, there is provided a keyboard/mouse set. The keyboard/mouse set includes a mouse and a keyboard. The mouse is permitted to be operated in a first resolution mode or a second resolution mode. The keyboard includes a switch element, which is triggered to generate a first instruction. The mouse is operated in the first resolution mode or the second resolution mode according to the first instruction.

In an embodiment of the keyboard/mouse set, the switch element includes a push switch, a rotary switch or a sensor switch.

In an embodiment of the keyboard/mouse set, when the switch element is triggered, the mouse is successively switched between the first resolution mode and the second resolution mode.

In an embodiment of the keyboard/mouse set, the switch element includes a first resolution switch and a second resolution switch. When the first resolution switch is triggered, the mouse is operated in the first resolution mode to control the motion of the cursor. Whereas, when the second resolution switch is triggered, the mouse is operated in the second resolution mode to control the motion of the cursor.

In an embodiment of the keyboard/mouse set, the computer system further includes a keyboard/mouse receiver. After the first instruction is wirelessly transmitted from the keyboard to the keyboard/mouse receiver, the keyboard/mouse receiver wirelessly issues a second instruction to the mouse, so that the mouse is operated in the first resolution mode or the second resolution mode to control the motion of the cursor according to the second instruction.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a mouse having adjustable pointer moving resolution according to the prior art;

FIG. 2A is a schematic diagram illustrating a computer system according to an embodiment of the present invention;

FIG. 2B is a schematic diagram illustrating a rotary switch as the switch element of the keyboard according to another embodiment of the present invention;

FIG. 2C is a schematic diagram illustrating a sensor switch used as the switch element of the keyboard according to another embodiment of the present invention;

FIG. 2D is a schematic diagram illustrating plural resolution switches used as the switch element of the keyboard according to another embodiment of the present invention; and

FIG. 2E is a schematic diagram illustrating another resolution value shown on the display screen of the computer system according to another embodiment of the present invention.

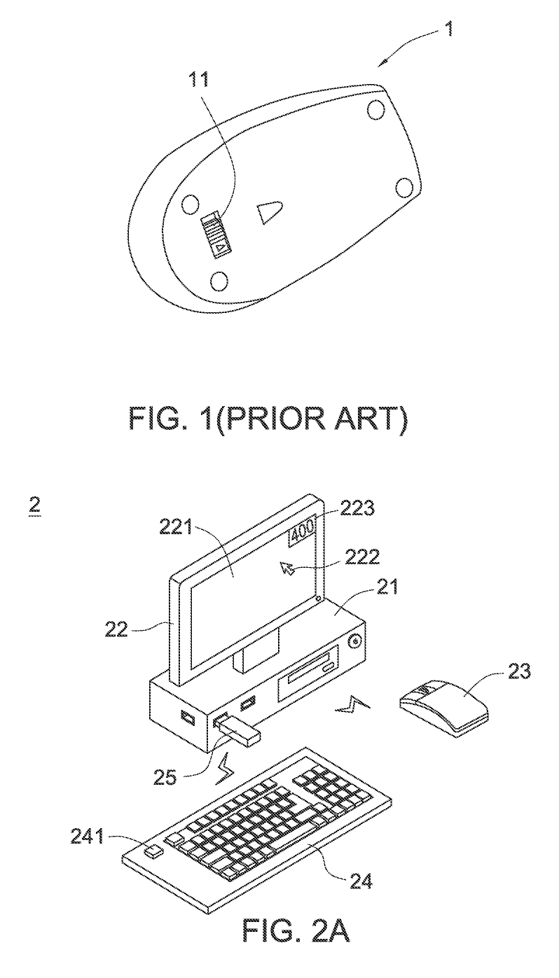

### DETAILED DESCRIPTION OF THE PREFERRED EMBODIMENT

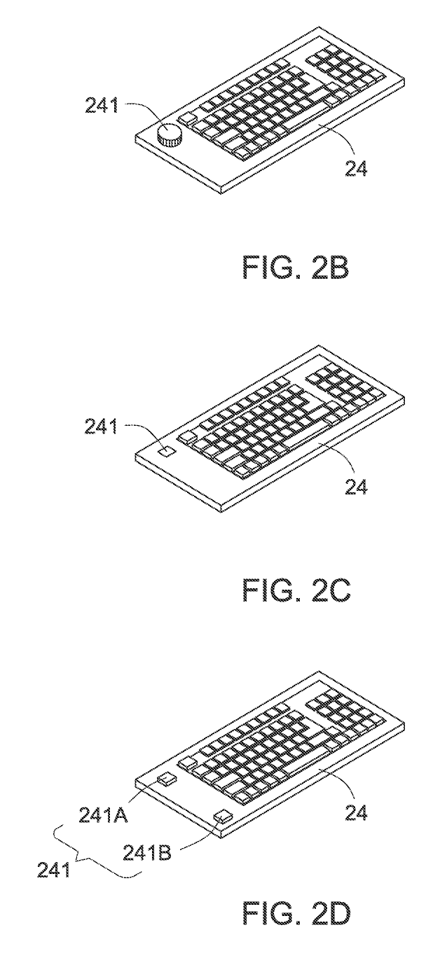

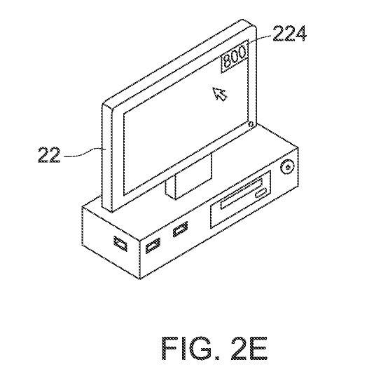

FIG. 2A is a schematic diagram illustrating a computer system according to an embodiment of the present invention. As shown in FIG. 2A, the computer system 2 comprises a host 21, a display screen 22 and a keyboard/mouse set. The keyboard/mouse set comprises a mouse 23 and a keyboard 24. The host 21 is used for controlling operations of the computer system 2. The host 21 comprises a motherboard, a processor, a memory and a connecting interface. An operating frame 221 of the computer system 2 is shown on the display screen 22. The operating frame 221 comprises a cursor 222. The mouse 23 is used for controlling the motion of the cursor 222 on the operating frame 221. In this embodiment, the mouse 23 has two resolution operating modes (e.g. a 400-DPI mode and an 800-DPI mode). Via the keyboard 24, the user may adjust or switch the resolution of the mouse 23. The keyboard 24 comprises a switch element 241. When the switch element 241 is triggered, an instruction is generated. In response to the instruction, the mouse 23 is operated in a first resolution operating mode or a second resolution operating mode, thereby controlling the motion of the cursor 222.

FIGS. 2A˜2D schematically illustrate several exemplary switch elements 241 used in the keyboard 24 of the present invention. In FIG. 2A, the switch elements 241 is a push switch. In FIG. 2B, the switch elements 241 is a rotary switch. In FIG. 2C, the switch elements 241 is a sensor switch. An example of the push switch includes a button or a key. When a depressing force is exerted on the push switch, the push switch generates an instruction. An example of the rotary switch includes a knob or a rotary disk. When the rotary switch is rotated in a direction, the rotary switch generates an instruction. An example of the sensor switch includes an optical switch, a capacitor switch or a resistor switch. When the sensor switch is touched by a user, the sensor switch generates an instruction.

Alternatively, the switch elements 241 may be a key that is originally provided on the keyboard 24. For example, when a computer game is implemented, a non-usage key of the keyboard 24 may be used as the switch element 241. Alternatively, a push switch, a rotary switch or a sensor switch that is additionally provided on the keyboard 24 may be used as the switch element 241. In this embodiment, the switch element 241 is arranged on the front surface of the keyboard 24. Alternatively, the switch element 241 is arranged on a lateral side of the keyboard 24 for facilitating the user to quickly search and trigger the switch element 241. Moreover, the user may intuitively move his (her) finger or palm to trigger the switch element 241 without the need of looking at the keyboard 24. As a consequence, the resolution of the mouse 23 could be quickly switched according to the practical requirements.

As shown in FIGS. 2A, 2B and 2C, a single switch element 241 is provided on the keyboard 24. By triggering the switch element 241, the mouse 23 is successively switched between the first resolution mode and the resolution mode (e.g. 400 DPI→800 DPI→400 DPI→800 DPI→ . . . ) to control the cursor. In some embodiments, the switch element 241 comprises two or more resolution switches. As shown in FIG. 2D, the switch element 241 comprises two resolution switches 241A and 241B. In a case that the first resolution switch 241A is triggered, the mouse 23 is operated in the first resolution mode (400 DPI) to control the cursor. Whereas, in a case that the second resolution switch 241B is triggered, the mouse 23 is operated in the second resolution operating mode (800 DPI) to control the cursor.

In the computer system 2 of the present invention, the current resolution mode of the mouse 23 could be shown on the operating frame 221 of the display screen to prompt the user whether the current resolution mode is desired. For example, when the mouse 23 is operated in the 400-DPI resolution mode, an icon 223 is shown on the operating frame 221 to prompt the user that the current operating mode of the mouse 23 is the 400-DPI resolution mode. As shown in FIG. 2A, the icon 223 exhibits a value indicating the current resolution of the mouse 23. On the other hand, when the mouse 23 is operated in the 800-DPI resolution mode, another icon 224 is shown on the operating frame 221 to prompt the user that the current operating mode of the mouse 23 is the 800-DPI resolution mode (see FIG. 2E).

In some embodiments of the computer system 2, the current resolution mode of the mouse 23 could be prompted by outputting other visual or sound effects. For example, lighting signals with different colors or shapes may be shown on the operating frame 221 to indicate different resolution mode. Alternatively, the computer system 2 has a sound generating device (e.g. a speaker) to broadcast the current resolution value or generate different sound signals. Alternatively, the mouse 23 has an indication lamp (not shown) for emitting lighting signals indicating different resolution modes.

The computer system 2 of the present invention comprises various combinations of the keyboard 24 and the mouse 23. The use of the keyboard 24 may select a desired resolution mode of mouse 23. For example, as shown in FIG. 2A, the keyboard 24 is wireless keyboard and the mouse 23 is a wireless mouse. Via a common keyboard/mouse receiver 25, the keyboard 24 and the mouse 23 are in communication with the host 21. The keyboard/mouse receiver 25 is connected to the host 21. When the switch element 241 of the keyboard 24 is triggered, the keyboard 24 generates a first instruction to the keyboard/mouse receiver 25 according to a wireless transmission technology. After receiving the first instruction, the keyboard/mouse receiver 25 issues a second instruction to the mouse 23 according to a wireless transmission technology. According to the second instruction, the mouse 23 is operated in the first resolution mode (400 DPI) or the second resolution operating mode (800 DPI) to control the motion of the cursor 222.

In some embodiments, the resolution of the mouse 23 may be controlled by the keyboard 24 through the host 21. For example, when the switch element 241 of the keyboard 24 is triggered, the keyboard 24 generates an instruction to the host 21. After receiving the instruction, the host 21 issues another instruction to the mouse 23. According to the instruction issued from the host 21, the mouse 23 is operated in the first resolution mode or the second resolution operating mode to control the motion of the cursor 222.

In accordance with the present invention, the keyboard 24 may issue an instruction to the host by at least three approaches. In a first approach, by connecting a keyboard receiver to the host, the keyboard may issue the instruction to the keyboard receiver according to a wireless transmission technology. In a second approach, the instruction is directly transmitted from the keyboard to the host according to a Bluetooth transmission technology. In a third approach, the instruction is transmitted from the keyboard to the host through a keyboard signal wire according to a wired transmission technology.

In accordance with the present invention, the host may issue an instruction to the mouse by at least three approaches. In a first approach, by connecting a mouse receiver to the host, the mouse receiver may issue the instruction to the mouse according to a wireless transmission technology. In a second approach, the instruction is directly transmitted from the host to the mouse according to a Bluetooth transmission technology. In a third approach, the instruction is transmitted from the host to the mouse through a mouse signal wire according to a wired transmission technology.

In the computer system 2 of the above embodiments, the mouse 23 has two resolution modes (400 DPI and 800 DPI). Nevertheless, the mouse 23 of the computer system 2 according to the present invention may be operated in more than two resolution modes. Depending on the sensing capability of the mouse, the number of resolution modes is increased. For example, the mouse may be operated in three resolution modes (400 DPI, 800 DPI and 1200 DPI), four resolution modes (400 DPI, 800 DPI, 1200 DPI and 1600 DPI) or more resolution modes. By means of the switch element 241 of the keyboard 24, a desired resolution mode of the mouse 23 is selected. Even if the mouse 23 is frequently moved, the user could directly manipulate the keyboard 24 that is usually immobile or seldom mobile to change the resolution mode of the mouse 23. As a consequence, the process of changing the mouse resolution is user-friendly and rapid. In addition, the possibility of causing switching error is minimized.

Moreover, in the computer system of the present invention, the host and the display screen may be separate devices. For example, the host is a host of a personal computer, and the display screen is externally connected to the personal computer. Alternatively, the host is a game console, and the display screen is externally connected to the game console. Alternatively, the host and the display screen may be integrated into for example a notebook computer, a netbook computer or an all-in-one computer.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A computer system, comprising:
a host for controlling operations of said computer system;
a display screen for showing an operating frame of said computer system, wherein a cursor is shown on said operating frame;
a mouse for controlling a motion of said cursor in a first resolution mode or a second resolution mode; and
a keyboard comprising a switch element, which is triggered to generate a first instruction, wherein said mouse is operated in said first resolution mode or said second resolution mode to control said motion of said cursor according to said first instruction.

2. The computer system according to claim 1 wherein said switch element includes a push switch, a rotary switch or a sensor switch.

3. The computer system according to claim 1 wherein when said switch element is triggered, said mouse is successively switched between said first resolution mode and said second resolution mode to control said motion of said cursor.

4. The computer system according to claim 1 wherein said switch element comprises a first resolution switch and a second resolution switch, wherein said mouse is operated in said first resolution mode to control said motion of said cursor when said first resolution switch is triggered, and said mouse is operated in said second resolution mode to control said motion of said cursor when said second resolution switch is triggered.

5. The computer system according to claim 1 wherein a first icon is shown on said operating frame when said mouse is operated in said first resolution mode to control said motion of said cursor, and a second icon is shown on said operating frame when said mouse is operated in said second resolution mode to control said motion of said cursor.

6. The computer system according to claim 5 wherein said first icon exhibits a first resolution value corresponding to said first resolution mode, and said second icon exhibits a second resolution value corresponding to said second resolution mode.

7. The computer system according to claim 1 further comprising a keyboard/mouse receiver connected to said host, wherein after said first instruction is wirelessly transmitted from said keyboard to said keyboard/mouse receiver, said keyboard/mouse receiver wirelessly issues a second instruction to said mouse, so that said mouse is operated in said first resolution mode or said second resolution mode to control said motion of said cursor according to said second instruction.

8. The computer system according to claim 1 wherein after said first instruction is transmitted from said keyboard to said host, said host issues a second instruction to said mouse, so that said mouse is operated in said first resolution mode or said second resolution mode to control said motion of said cursor according to said second instruction.

9. The computer system according to claim 8 further comprising a keyboard receiver connected to said host, wherein said first instruction is wirelessly transmitted from said keyboard to said keyboard receiver.

10. The computer system according to claim 8 wherein said first instruction is transmitted from said keyboard to said host according to a Bluetooth transmission technology.

11. The computer system according to claim 8 wherein said first instruction is transmitted from said keyboard to said host through a keyboard signal wire.

12. The computer system according to claim 8 further comprising a mouse receiver connected to said host, wherein said second instruction is wirelessly transmitted from said mouse receiver to said mouse.

13. The computer system according to claim 8 wherein said second instruction is wirelessly transmitted from said host to said mouse according to a Bluetooth transmission technology.

14. The computer system according to claim 8 wherein said second instruction is transmitted from said host to said mouse through a mouse signal wire.

15. A keyboard/mouse set, comprising:
a mouse permitted to be operated in a first resolution mode or a second resolution mode; and
a keyboard comprising a switch element, which is triggered to generate a first instruction, wherein said mouse is operated in said first resolution mode or said second resolution mode according to said first instruction.

16. The keyboard/mouse set according to claim 15 wherein said switch element includes a push switch, a rotary switch or a sensor switch.

17. The keyboard/mouse set according to claim 15 wherein when said switch element is triggered, said mouse is successively switched between said first resolution mode and said second resolution mode.

18. The keyboard/mouse set according to claim 15 wherein said switch element comprises a first resolution switch and a second resolution switch, wherein said mouse is operated in said first resolution mode to control said motion of said cursor when said first resolution switch is triggered, and said mouse is operated in said second resolution mode to control said motion of said cursor when said second resolution switch is triggered.

19. The keyboard/mouse set according to claim 15 further comprising a keyboard/mouse receiver, wherein after said first instruction is wirelessly transmitted from said keyboard to said keyboard/mouse receiver, said keyboard/mouse receiver wirelessly issues a second instruction to said mouse, so that said mouse is operated in said first resolution mode or said second resolution mode to control said motion of said cursor according to said second instruction.
